(19) United States
(12) Patent Application Publication
(10) Pub. No.: US 2007/0126408 A1
(43) Pub. Date: Jun. 7, 2007

(54) Power supply device and electronic equipment comprising same

(76) Inventor: Masaru Sakai, Kyoto (JP)

Correspondence Address: ROHM CO., LTD.;C/O KEATING & BENNETT, LLP, 8180 GREENSBORO DRIVE, SUITE 850, MCLEAN, VA, 22102, US

(21) Appl. No.: 10/569,894

(22) PCT Filed: Aug. 23, 2004
(86) PCT No.: PCT/JP04/12051

§ 371 Date: Oct. 16, 2006

(30) Foreign Application Priority Data
Aug. 29, 2003 (JP) 2003-307710

(51) Int. Cl. G05F 1/00

(52) U.S. Cl. 323/274

(57) ABSTRACT

A low-power consumption power supply device that is capable of supplying an adequate current in the case of a heavy load and achieving a rapid transient response when the load fluctuates. The power supply device includes NMOS-type output transistors that are provided between the input power supply that supplies power to the output terminal and ground potential, a reference voltage generation circuit that generates a reference voltage, and differential amplifier circuits that control each of the NMOS-type output transistors by having an output supply voltage inputted to the differential amplifier circuits as feedback and by comparing the output supply voltage with the reference voltage, wherein the differential amplifier circuits provide an input offset voltage between the inputted reference voltage and output supply voltage in order to provide the output supply voltage with a voltage range in which the NMOS-type transistors are both OFF.

### BACKGROUND OF THE INVENTION

1. Field of the Invention

The present invention relates to a push-pull type power supply device suitable for a high-speed memory device and to electronic equipment which comprises the power supply device and which employs the output of the power supply device as a power supply for termination.

2. Description of the Related Art

In recent years, the development of memory devices with increased data transfer speeds has been actively pursued in accordance with the higher functionality of electronic equipments. Among such memory devices, as memory devices that raise the data transfer speed of synchronous DRAM (SDRAM) that runs in sync with a clock signal, DDR (Double Data Rate) synchronous DRAM (DDR-SDRAM), which synchronizes data transfer with both the leading and trailing edges of the clock signal, has been put to practical use.

Further, for the purpose of this high-speed data transfer, DDR-SDRAM adopts a high-speed, small-amplitude interface that employs a power supply voltage for termination and a reference voltage (Patent Document 1, for example). FIG. 4 is a partial circuit diagram of electronic equipment showing the constitution of the interface. This electronic equipment 49 comprises a controller 51 constituting a microcomputer, for example, a DDR-SDRAM 52, and a power supply device for termination 50 for outputting a power supply voltage for termination (VTT). The controller 51 and DDR-SDRAM 52 are connected by a signal line via an interface resistor 53 and the signal line and the power supply for termination (VTT) of the power supply device for termination 50 are connected via an interface resistor 54 at an interconnection point N1 on the side of the DDR-SDRAM 52 of the interface resistor 53.

In this example, the system power supply (VDD) of the controller 51 and DDR-SDRAM 52 is 2.5V, the power supply voltage for termination (VTT) and reference voltage (VREF) are 1.25V, and the resistance values of the interface resistors 53 and 54 are equal. The output circuit 61 of the controller 51 is constituted in the CMOS format and outputs 2.5V as the high level and OV as the low level. The voltages of the high and low levels are divided by interface resistors 53 and 54 and are each afforded a small amplitude to become 1.875V and 0.625V respectively at interconnection point N1. These small-amplitude signals are inputted to the non-inversion input terminal of an input signal differential amplifier 62 of the DDR-SDRAM 52 and, by means of a comparison with the 1.25V of the reference voltage (VREF) that is inputted to the inversion input terminal, are judged at high speed to be high level or low level signals.

Therefore, in order to implement an interface for affording signals a small amplitude at such a high speed, the power supply device for termination 50 for outputting the power supply voltage for termination (VTT) and reference voltage (VREF) is required. A conventional power supply device that is used as the power supply device for termination 50 is shown in FIG. 5. This power supply device 101 is the so-called push-pull type and outputs the power supply voltage for termination (VTT) from the power supply voltage output terminal for termination (VTT output terminal) and the reference voltage (VREF) from a reference voltage output terminal (VREF output terminal).

The power supply device 101 is constituted by a reference voltage generation circuit 106 that generates the reference voltage (VREF) by dividing the voltage of the system power supply (VDD) by means of the resistors 117 and 118 and outputs the reference voltage (VREF) via a buffer amplifier 115, a PMOS-type transistor 111, which is connected to the VTT output terminal, and an NMOS-type transistor 112, and a differential amplifier 113 that controls the PMOS-type transistor 111 and NMOS-type transistor 112 as a result of the power supply voltage for termination (VTT) being inputted to the differential amplifier 113 as feedback and by comparing the power supply voltage for termination (VTT) with the reference voltage (VREF). Further, the resistors 117 and 118 have equal resistance values.

The reference voltage generation circuit 106 generates 1.25V as the reference voltage (VREF) as a result of the division by resistors 117 and 118 of the system power supply, that is, the input power supply (VDD), which is 2.5V. Further, a feedback loop comprising the differential amplifier 113, PMOS-type transistor 111, and NMOS-type transistor 112 is created so that the power supply voltage for termination (VTT) matches the reference voltage (VREF).

Patent Document 1: Japanese Patent Application Laid Open No. 2001-195884

Thus, the power supply device 101 is able to output the power supply voltage for termination (VTT) and the reference voltage (VREF). These voltages are intermediate voltages substantially in the middle of the voltage of the input supply (VDD) and ground potential. Because the PMOS-type transistor 111 and NMOS-type transistor 112 are both ON, the short-circuit current flowing through these transistors is large and, as a result, the power consumption of the power supply device 101 is large.

Further, in order that an adequate current should be supplied in the case of a heavy load and in order to achieve a rapid transient response when the load fluctuates, the current drive performance of the PMOS-type transistor 111 must be increased. However, the maximum current performance of the PMOS-type transistor 111 occurs when the gate voltage of the PMOS-type transistor 111 is ground potential and is therefore limited.

### SUMMARY OF THE INVENTION

The present invention was conceived in view of the above situation and an object of the present invention is to provide a power supply device that permits reduced power consumption in addition to being capable of supplying an adequate current in the case of a heavy load and of achieving a rapid transient response when the load fluctuates, and an electronic equipment capable of achieving a higher performance by using the power supply device.

In order to solve the above problem, the power supply device of the present invention is a power supply device that outputs an output supply voltage from an output terminal, comprising: a reference voltage generation circuit for generating a reference voltage; a first NMOS-type transistor, the drain of which is connected to an input power supply that supplies power to the output terminal, and the source of which is connected to the output terminal; a second NMOS-type transistor, the drain of which is connected to the output terminal, and the source of which is connected to ground potential; and first and second differential amplifier circuits to which the output supply voltage is inputted as feedback and which control the first and second NMOS-type transistors by comparing the output supply voltage with the reference voltage inputted by the reference voltage generation circuit, wherein the first and second differential amplifier circuits provide an input offset voltage between the inputted reference voltage and the inputted output supply voltage in order to provide the output supply voltage with a voltage range in which the first and second NMOS-type transistors are both OFF.

A further power supply device of the present invention is a power supply device that outputs an output supply voltage from an output terminal, comprising: a reference voltage generation circuit that generates an upper reference voltage and a lower reference voltage; a first NMOS-type transistor, the drain of which is connected to an input power supply that supplies power to the output terminal, and the source of which is connected to the output terminal; a second NMOS-type transistor, the drain of which is connected to the output terminal, and the source of which is connected to ground potential; a first differential amplifier circuit to which the output supply voltage is inputted as feedback and which controls the first NMOS-type transistor by comparing the output supply voltage with the lower reference voltage; and a second differential amplifier circuit to which the output supply voltage is inputted as feedback and which controls the second NMOS-type transistor by comparing the output supply voltage with the upper reference voltage, wherein the output supply voltage is provided with a voltage range in which the first and second NMOS-type transistors are both OFF.

Furthermore, these power supply devices are such that the input power supply of the first differential amplifier circuit can also be made a higher voltage than that of the input power supply that supplies power to the output terminal.

The electronic equipment according to the present invention is an electronic equipment comprising any of the abovementioned power supply devices, a memory device, and a controller, wherein the memory device and controller are connected by at least one signal line via a first resistor and the output terminal of the power supply device is connected to the memory device side of the signal line via a second resistor as a power supply for termination.

According to the power supply device of the present invention, because the transistor on the input power supply side connected to the output terminal is an NMOS-type transistor, an adequate current can be supplied in the case of a heavy load and a rapid transient response can be achieved when the load fluctuates. Further, because an input offset voltage is provided between the inputted reference voltage and the inputted output supply voltage in the first and second differential amplifier circuits in order to provide the output supply voltage with a voltage range in which the first and second NMOS-type transistors are both off, a short-circuit current is prevented from flowing and, as a result, low power consumption can be achieved. Further, the electronic equipment of the present invention can implement an interface that affords a signal a small amplitude at high speed by using this power supply device and is able to adapt to a high performance.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a circuit diagram of a power supply device according to an embodiment of the present invention.

FIG. 2 is a circuit diagram of an offset voltage generation circuit of the power supply device thereof.

FIG. 3 is a circuit diagram of a power supply device according to another embodiment of the present invention.

FIG. 4 is a partial circuit diagram of an electronic equipment that constitutes an interface that affords a signal a small amplitude at high speed.

FIG. 5 is a circuit diagram of a power supply device of the prior art.

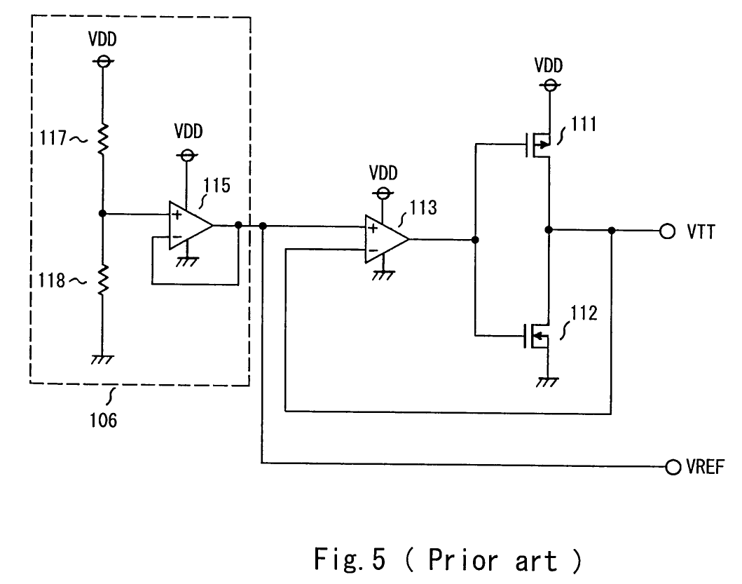

### DETAILED DESCRIPTION OF PREFERRED EMBODIMENTS

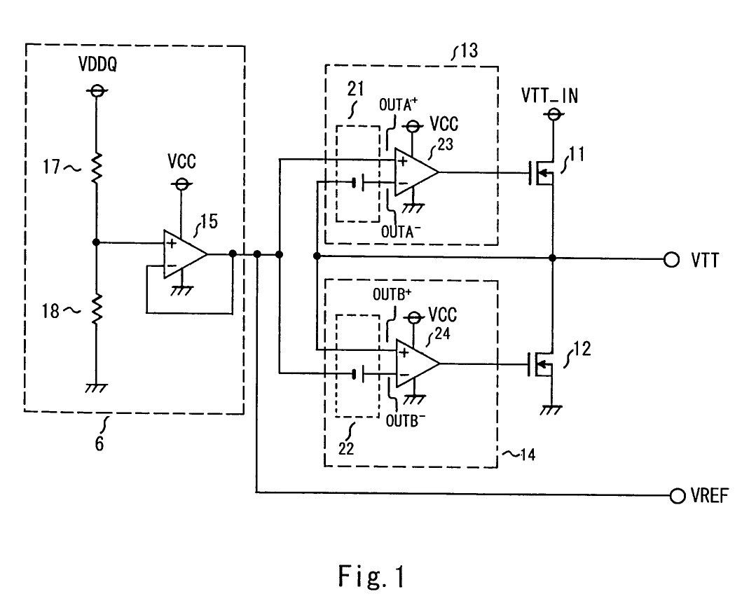

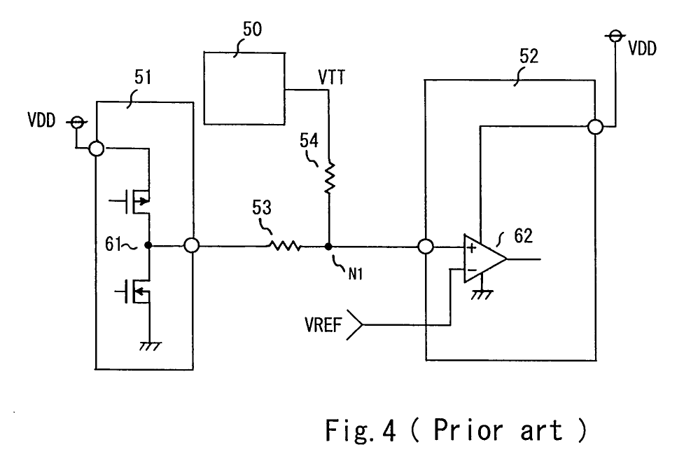

Embodiments of the present invention used in the electronic equipment shown in FIG. 4 above will be described hereinbelow with reference to the drawings. FIG. 1 is a circuit diagram of a power supply device 1 constituting an embodiment of the present invention.

The power supply device 1 is the so-called push-pull type and outputs an output power supply voltage, that is, the power supply voltage for termination (VTT) from a power supply voltage output terminal for termination (VTT output terminal) and a reference voltage (VREF) from a reference voltage output terminal (VREF output terminal). The power supply device 1 comprises a reference voltage generation circuit 6 that generates the reference voltage (VREF), a first NMOS-type transistor 11 the drain of which is connected to an input power supply (VTT_IN) and the source of which is connected to the VTT output terminal, a second NMOS-type transistor 12 the drain of which is connected to the VTT output terminal and the source of which is grounded, and first and second differential amplifier circuits 13 and 14 respectively that control the first and second NMOS-type transistors 11 and 12 respectively by having the power supply voltage for termination (VTT) inputted thereto as feedback and comparing the power supply voltage for termination (VTT) with the reference voltage (VREF). Therefore, the first differential amplifier circuit 13 and the first NMOS-type transistor 11 form a first feedback loop and the second differential amplifier circuit 14 and the second NMOS-type transistor 12 form a second feedback loop. Further, a stabilizing capacitor (not shown) that stabilizes the power supply voltage for termination (VTT) is connected to the VTT output terminal. Further, the power supply device 1 flexibly adapts to the electronic equipment using the power supply device 1 and therefore comprises three types of input power supplies (VTT_IN, VDDQ, VCC). The specific voltages will be described subsequently.

The reference voltage generation circuit 6 is constituted by resistors 17 and 18 that generate a reference voltage (VREF) by dividing the voltage of the input power supply (VDDQ) and a buffer amplifier 15 that outputs the reference voltage (VREF). The resistors 17 and 18 have equal resistance values. The reference voltage (VREF) is outputted from the reference voltage output terminal (VREF output terminal) to the outside and outputted to the first differential amplifier circuit 13 and second differential amplifier circuit 14.

The first differential amplifier circuit 13 is constituted by a first off set voltage generation circuit 21 and a first operational amplifier 23. The first offset voltage generation circuit 21 receives inputs of the power supply voltage for termination (VTT) of the first feedback loop and the reference voltage (VREF) that is outputted by the reference voltage generation circuit 6 and adds relatively an offset voltage to the power supply voltage for termination (VTT). Further, thrower supply voltage for termination (VTT) to which an offset voltage has been added is inputted to the inversion input terminal of the first operational amplifier 23 and the reference voltage (VREF) is inputted to the non-inversion input terminal of the first operational amplifier 23. Therefore, the first differential amplifier circuit 13 outputs an intermediate voltage by equalizing the power supply voltage for termination (VTT) to a voltage that is lower than the reference voltage (VREF) to the extent of the offset voltage. That is, the first NMOS-type transistor 11 is off when the power supply voltage for termination (VTT) is at or above a voltage that is lower than the reference voltage (VREF) to the extent of the offset voltage.

The second differential amplifier circuit 14 is constituted by a second offset voltage generation circuit 22 and a second operational amplifier 24. The second offset voltage generation circuit 22 receives inputs of the power supply voltage for termination (VTT) of the second feedback loop and the reference voltage (VREF) outputted by the reference voltage generation circuit 6 and adds relatively an offset voltage to the reference voltage (VREF). Further, the reference voltage (VREF) to which the offset voltage has been added is inputted to the inversion input terminal of the second operational amplifier 24 and the power supply voltage for termination (VTT) is inputted to the non-inversion input terminal of the second operational amplifier 24. Therefore, the second differential amplifier circuit 14 outputs the intermediate voltage by equalizing the power supply voltage for termination (VTT) to a voltage that is higher than the reference voltage (VREF) to the extent of the offset voltage. That is, the second NMOS-type transistor 12 is off when the power supply voltage for termination (VTT) is at or below a voltage that is higher than the reference voltage (VREF) to the extent of the offset voltage.

Thus, by adding relatively an offset voltage to the fed back power supply voltage for termination (VTT) and the reference voltage (VREF), the first differential amplifier circuit 13 and second differential amplifier circuit 14 have an input offset voltage and a voltage range in which the first NMOS-type transistor 11 and second NMOS-type transistor 12 are both OFF is provided for the power supply voltage for termination (VTT).

Here, the voltage range in which the first NMOS-type transistor 11 and second NMOS-type transistor 12 are both OFF is established by considering the shift voltage from the reference voltage (VREF) that the power supply voltage for termination (VTT) is allowed. For example, the power supply voltage for termination (VTT) is allowed a range of ±30 mV with respect to the reference voltage (VREF). Further, in this embodiment, the first and second NMOS-type transistors are both OFF when the power supply voltage for termination (VTT) is in the ±5 mV range with respect to the reference voltage (VREF). As a result, the offset voltage of the first offset voltage generation circuit 21 and second offset voltage generation circuit 22 is 5 mV.

The voltages of the respective parts of the power supply device 1 will be described next. In this embodiment, the input power supply (VCC) of the first differential amplifier circuit 13, second differential amplifier circuit 14, and buffer amplifier 15 is set at 5V, and the input power supply (VTT_IN) of the first NMOS-type transistor 11 and the input power supply (VDDQ) inputted to the resistors 17 and 18 are stepped down from the input power supply (VCC) by means of a regulator (not shown) and established at 2.5V, which is the same as the system power supply (VDD) described above in FIG. 4. Therefore, the reference voltage (VREF) generated by the division of resistors 17 and 18 from the voltage 2.5V of the input power supply (VDDQ) is 1.25V.

Further, when the power supply voltage for termination (VTT) drops below 1.25V−5 mV, the first NMOS-type transistor 11 turns ON as a result of the first feedback loop and the power supply voltage for termination (VTT) is raised. Likewise, when the power supply voltage for termination (VTT) exceeds 1.25V+5 mV, the second NMOS-type transistor 12 turns ON as a result of the second feedback loop, whereby the power supply voltage for termination (VTT) is reduced. Thus, the power supply voltage for termination (VTT) is maintained substantially in the range of 1.25V±5 mV.

As detailed above, the power supply device 1 is capable of improving the transient response characteristic and so forth by separately optimizing the first differential amplifier circuit 13 and second differential amplifier circuit 14 that separately control the first and second NMOS-type transistors. Further, because the first and second NMOS-type transistors are both turned OFF in a range where the power supply voltage for termination (VTT) is fixed with respect to the reference voltage (VREF), when the load connected to the VTT output terminal is a no-load or when the load fluctuates, it is possible to prevent a short-circuit current from flowing from the first NMOS-type transistor to the second NMOS-type transistor and low power consumption can be achieved.

Furthermore, the first differential amplifier circuit 13 and second differential amplifier circuit 14 establish the input power supply (VCC) at 5V and, therefore, a maximum of 5V can be outputted. Therefore, the gate voltage of the first NMOS-type transistor 11 and second NMOS-type transistor 12 can be set higher than the input power supply (VTT_IN) and the current driving performance of the first NMOS-type transistor 11 and second NMOS-type transistor 12 can also be made high. As a result, an adequate current can be supplied even in the case of a heavy load and a rapid transient response of the load fluctuations can be achieved.

Further, the input power supply (VTT_IN) of the first NMOS-type transistor 11 and the input power supply (VDDQ) inputted to the resistors 17 and 18 are equal voltages in this embodiment, being specifically set at 2.5V, but may also be different. That is, the current capacity of the first NMOS-type transistor 11 can be increased by raising the voltage of the input power supply (VTT_IN). However, in this case, another regulator for the input power supply (VTT_IN) is required and the power loss of the first NMOS-type transistor 11 increases.

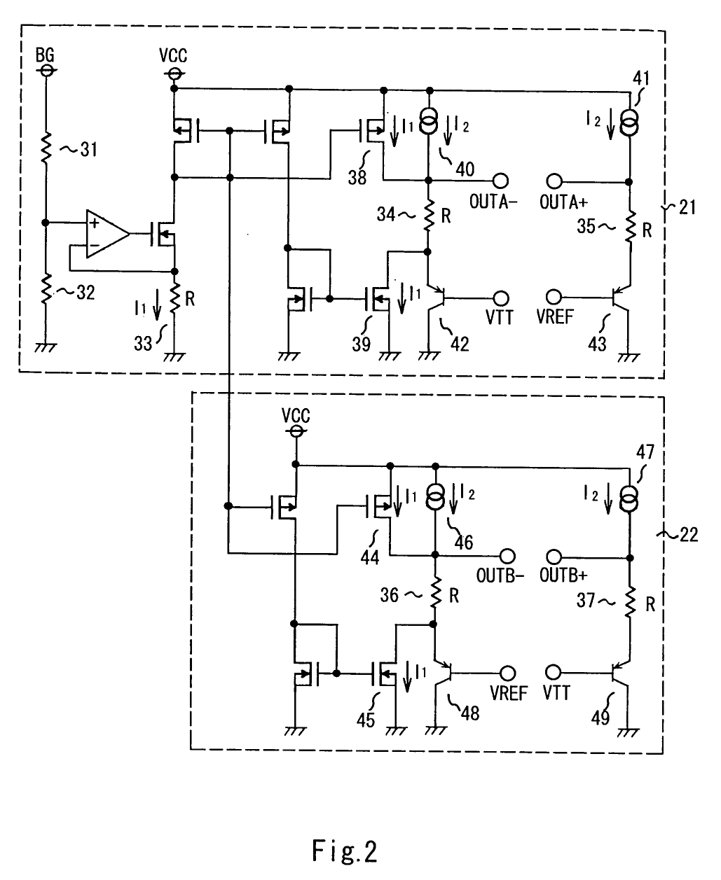

Thereafter, the specific circuit constitutions of the first offset voltage generation circuit 21 and second offset voltage generation circuit 22 are shown in FIG. 2. The power supply BG is a bandgap-type constant voltage source whose voltage is divided by resistors 31 and 32 to generate 5 mV. A current (I1) that corresponds with 5 mV then flows to a resistor 33. Current (I1) is transmitted by a current mirror circuit and flows to a PMOS-type transistor 38 and an NMOS-type transistor 39 that are serially connected to the two ends of a resistor 34 and to a PMOS-type transistor 44 and an NMOS-type transistor 45 that are serially connected to the two ends of a resistor 36. Here, the resistors 34 and 36, and resistors 35 and 37 (described subsequently) have a resistance value R that is equal to that of resistor 33.

A constant current source 40 through which a current (I2) flows arranged in parallel to the PMOS-type transistor 38 is connected to the interconnection point between the resistor 34 and PMOS-type transistor 38, which constitutes a terminal (OUTA-) that makes an output to the inversion input terminal of the first operational amplifier 23. The emitter of a PNP-type transistor 42 arranged in parallel to the NMOS-type transistor 39 is connected to the interconnection point between the resistor 34 and NMOS-type transistor 39. Further, the two ends of the resistor 35 are connected to a constant current source 41 through which the current (I2) flows and the emitter of a PNP-type transistor 43 respectively. The interconnection point between the resistor 35 and constant current source 41 is a terminal (OUTA+) that makes an output to the non-inversion input terminal of the first operational amplifier 23. In addition, the power supply voltage for termination (VTT) is inputted to the base of the PNP-type transistor 42 and the reference voltage (VREF) is inputted to the base of the PNP-type transistor 43.

Furthermore, a constant current source 46 through which the current (I2) flows arranged in parallel to the PMOS-type transistor 44 is connected to the interconnection point between the resistor 36 and the PMOS-type transistor 44, which constitutes a terminal (OUTB−) that makes an output to the inversion input terminal of the second operational amplifier 24. The emitter of a PNP-type transistor 48 arranged in parallel to the NMOS-type transistor 45 is connected to the interconnection point between the resistor 36 and NMOS-type transistor 45. Further, the two ends of the resistor 37 are connected to the emitter of a PNP-type transistor 49 and a constant current source 47 through which the current (I2) flows. The interconnection point between the resistor 37 and the constant current source 47 is a terminal (OUTB+) that makes an output to the non-inversion input terminal of the second operational amplifier 24. In addition, the reference voltage (VREF) is inputted to the base of the PNP-type transistor 48 and the power supply voltage for termination (VTT) is inputted to the base of the PNP-type transistor 49.

When the power supply voltage for termination (VTT) is inputted to the base of the PNP-type transistor 42, the terminal (OUTA−) is at the voltage VTT+Vf+(I1+I2)×R. Further, when the reference voltage (VREF) is inputted to the base of the PNP-type transistor 43, the terminal (OUTA+) is at the voltage VREF+Vf+I2×R. Here, Vf is the forward bias voltage of the transistor. Therefore, the voltage difference between the terminal (OUTA−) and terminal (OUTA+) is VTT−VREF+I1×R. Hence, as I1×R is 5 mV, the offset voltage 5 mV is added relatively to the power supply voltage for termination (VTT).

Likewise, when the reference voltage (VREF) is inputted to the base of the PNP-type transistor 48, the terminal (OUTB−) is the voltage VREF+Vf+(I1+I2)×R. Further, when the power supply voltage for termination (VTT) is inputted to the base of the PNP-type transistor 49, the terminal (OUTB+) is at the voltage VTT+Vf+I2×R. Therefore, the voltage difference between terminals (OUTB−) and (OUTB+) is VREF−VTT+I1×R. Hence, the offset voltage 5 mV is added relatively to the reference voltage (VREF).

With such a constitution, an accurate offset voltage can be generated by the first offset voltage generation circuit 21 and second offset voltage generation circuit 22. However, as long as the allowable voltage range (±30 mV) of the power supply voltage for termination (VTT) is satisfied, further constitutions are also possible.

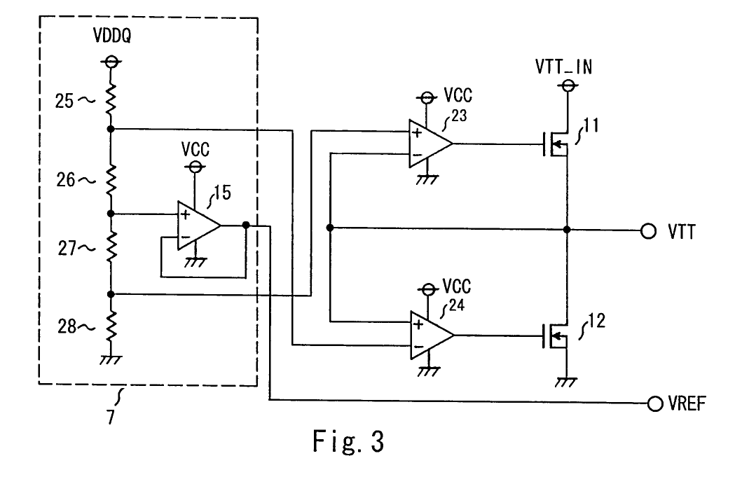

The power supply device constituting another embodiment of the present invention will be described next based on FIG. 3. In the power supply device 2, the first operational amplifier 23 and second operational amplifier 24 are first and second differential amplifier circuits as is without the first offset voltage generation circuit 21 and second offset voltage generation circuit 22 of the power supply device 1 as constituent elements. The reference voltage generation circuit 7 generates an upper reference voltage and a lower reference voltage in addition to generating the reference voltage (VREF). The upper reference voltage is inputted to the inversion input terminal of the second operational amplifier 24 and the lower reference voltage is inputted to the non-inversion input terminal of the first operational amplifier 23. The power supply voltage for termination (VTT) is inputted directly to the inversion input terminal of the first operational amplifier 23 and to the non-inversion input terminal of the second operational amplifier 24.

In the reference voltage generation circuit 7, resistors 25, 26, 27, and 28, which divide the voltage of the input power supply (VDDQ), are connected in that order between the input power supply (VDDQ) and ground potential. Further, reference voltage generation circuit 7 outputs the voltage at the interconnection point between resistors 26 and 27 as the reference voltage (VREF) passing through the buffer amplifier 15, the voltage at the interconnection point between the resistors 25 and 26 as the upper reference voltage, and the voltage at the interconnection point between the resistors 27 and 28 as the lower reference voltage. Here, the resistance values are established so that the difference between the upper reference voltage and reference voltage (VREF) and the difference between the reference voltage (VREF) and the lower reference voltage are both 5 mV.

The power supply device 2 is capable of outputting the power supply voltage for termination (VTT) with the voltage range in which the first NMOS-type transistor 11 and second NMOS-type transistor 12 are both OFF like the power supply device 1. Further, the circuit for generating the upper reference voltage and the lower reference voltage of the power supply device 2 can also have another circuit constitution.

Further, the power supply device 1 (or 2) can be used in the electronic equipment 49 that was described on the basis of FIG. 4 in the prior art. That is, the power supply device 1 (or 2) is employed as the power supply device for termination 50 in FIG. 4. The controller 51 and DDR-SDRAM 52 are connected by a signal line via the first interface resistor 53. The signal line and the VTT output terminal of the power supply device 1 (or 2) are connected via the second interface resistor 54 at the interconnection point N1 of the DDR-SDRAM 52 side of the interface resistor 53. In addition, the output of the VREF output terminal of the power supply device 1 (or 2) is inputted as the reference voltage (VREF) of an input signal differential amplifier circuit 62 of the DDR-SDRAM 52. Thus, an interface that affords a signal a small amplitude at high speed can be implemented for the electronic equipment shown in FIG. 4.

Further, the power supply device 1 (or 2) has a terminal (VREF terminal) that outputs the reference voltage (VREF) to the outside and the output is the reference voltage (VREF) of the above-mentioned interface. However, the reference voltage of the interface can be outputted from another device instead of providing the power supply device 1 (or 2) with the VREF terminal.

A power supply device that outputs the power supply voltage for termination (VTT) and electronic equipment that employs this power supply device were described hereinabove as an embodiment of the present invention. However, the power supply device of the present invention can also be applied to a case where another supply voltage with an allowable voltage range is outputted and can also be used in other electronic equipments.

Moreover, the present invention is not limited to the above embodiment. Various design modifications are possible within the scope of the items appearing in the claims. For example, it is understood that specific voltage values such as the power supply voltage for termination (VTT) and reference voltage (VREF) mentioned in the embodiment can be optionally chosen to suit the respective electronic equipments.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-4. (canceled)

5. A power supply device that outputs an output supply voltage from an output terminal, comprising:
a reference voltage generation circuit for generating a reference voltage;
a first NMOS-type transistor, the drain of which is connected to an input power supply that supplies power to the output terminal, and the source of which is connected to the output terminal;
a second NMOS-type transistor, the drain of which is connected to the output terminal, and the source of which is connected to ground potential; and
first and second differential amplifier circuits to which the output supply voltage is inputted as feedback and which control the first and second NMOS-type transistors by comparing the output supply voltage with the reference voltage inputted by the reference voltage generation circuit, wherein
the first and second differential amplifier circuits provide an input offset voltage between the inputted reference voltage and the inputted output supply voltage in order to provide the output supply voltage with a voltage range in which the first and second NMOS-type transistors are both OFF.

6. The power supply device according to claim 5, wherein the input power supply of the first differential amplifier circuit is a higher voltage than that of the input power supply that supplies power to the output terminal.

7. An electronic equipment comprising the power supply device according to claim 5, a memory device, and a controller, wherein
the memory device and controller are connected by at least one signal line via a first resistor, and
the output terminal of the power supply device is connected to the memory device side of the signal line via a second resistor as a power supply for termination.

8. A power supply device that outputs an output supply voltage from an output terminal, comprising:
a reference voltage generation circuit that generates an upper reference voltage and a lower reference voltage;
a first NMOS-type transistor, the drain of which is connected to an input power supply that supplies power to the output terminal, and the source of which is connected to the output terminal;
a second NMOS-type transistor, the drain of which is connected to the output terminal, and the source of which is connected to ground potential;
a first differential amplifier circuit to which the output supply voltage is inputted as feedback and which controls the first NMOS-type transistor by comparing the output supply voltage with the lower reference voltage; and
a second differential amplifier circuit to which the output supply voltage is inputted as feedback and which controls the second NMOS-type transistor by comparing the output supply voltage with the upper reference voltage, wherein
the output supply voltage is provided with a voltage range in which the first and second NMOS-type transistors are both OFF.

9. The power supply device according to claim 8, wherein the input power supply of the first differential amplifier circuit is a higher voltage than that of the input power supply that supplies power to the output terminal.

10. An electronic equipment comprising the power supply device according to claim 8, a memory device, and a controller, wherein
the memory device and controller are connected by at least one signal line via a first resistor, and
the output terminal of the power supply device is connected to the memory device side of the signal line via a second resistor as a power supply for termination.
